(19) United States
(12) Patent Application Publication
(10) Pub. No.: US 2010/0116302 A1
(43) Pub. Date: May 13, 2010

(54) DEVICE FOR CLEANING A SUPPORT

(76) Inventor: Frederic Ficher, Cannes (FR)

Correspondence Address: JAMES C. LYDON, 100 DAINGERFIELD ROAD, SUITE 100, ALEXANDRIA, VA, 22314, US

(21) Appl. No.: 12/597,492

(22) PCT Filed: Apr. 22, 2008
(86) PCT No.: PCT/FR08/00569

§ 371 Date: Oct. 24, 2009

(30) Foreign Application Priority Data
Apr. 24, 2007 (FR) 0754673

(51) Int. Cl. B08B 3/00

(52) U.S. Cl. 134/198

(57) ABSTRACT

The invention relates to a device for cleaning a support comprising: a casing, at least one cleaning-liquid spray means mounted on the casing, characterized in that it also comprises means for adjusting a distance between the spray means and the support.

The invention relates to cleaning devices.

In particular, the invention relates to fabric cleaning devices, such as, for example, shade fabrics.

However, the present invention is not limited to this specific application. It encompasses the cleaning of any surface, for example, the facade of a building or a terrace. For these reasons, in the remainder of the present patent application, we will call the object to be cleaned the “support,” without this terminology being considered limiting in any way.

We are familiar with a cleaning device comprising a nozzle intended to project a cleaning liquid under high pressure upon the support to be cleaned. This device can only be used to wash small surfaces during a pass. Therefore, several successive passes over the support are required in order to clean it in its entirety. However, because of the deformability of the support, especially when it is made from fabric, the distance between the cleaning nozzle and the support is not constant during passes of the device. Consequently, cleaning is not uniform and marks remain. Finally, repeated passes of the device result in wear of the support.

An object of the invention is to provide a device for uniformly washing a support without wear.

To that end, the invention provides for a cleaning device for a support, comprising a casing and at least one cleaning-liquid spray means mounted on the casing. The device also has means for adjusting the distance between the spray means and the support.

According to another advantageous characteristic of the present invention, the casing has at least two cleaning-liquid spray means.

Thus, the use of at least two cleaning-liquid spray means allows the liquid to be sprayed homogeneously onto the support so as to clean the latter uniformly. Additionally, the possibility of adjusting the distance between the spray means and the support allows older materials to be cleaned, whose composition and relief differ, without the risk of damaging their surface.

Advantageously, but optionally, the assembly has at least one of the following characteristics:
when placed in a cleaning direction, one of the cleaning-liquid spray means of the device is offset with respect to the other in the direction of cleaning
the device also comprises at least three points of contact between the casing and the support
the device comprises four points of contact with the support
the points of contact are wheels
the device also comprises means articulated with the casing capable of accepting device handling means
the cleaning-liquid spray means have an opening with a principal dimension on the order of 0.3 mm
when the device is in operation, the cleaning-liquid spray means have an acute spray channel angle
the spray aperture angle has a value of approximately 40°
the cleaning-liquid spray means are arranged in such a way as to support, during operation, an allowable pressure comprised between approximately 30 bars and approximately 130 bars
the cleaning-liquid spray means are arranged in such a way as to support, during operation, an allowable temperature comprised between approximately 30° C. and approximately 100° C.
the device also comprises means for stiffening the cleaning-liquid feed system, mounted on a the cleaning-liquid spray means feed system, behind said spray means with respect to the support
the cleaning-liquid spray means are high-pressure nozzles

According to the invention, a support cleaning system comprising a pressurized machine for supplying cleaning liquid and a device having at least one of the previous characteristics is also provided.

Other characteristics and benefits of the invention will be made clear from the following description, which is purely illustrative and non-limiting, and should be read in conjunction with the attached drawings, in which:

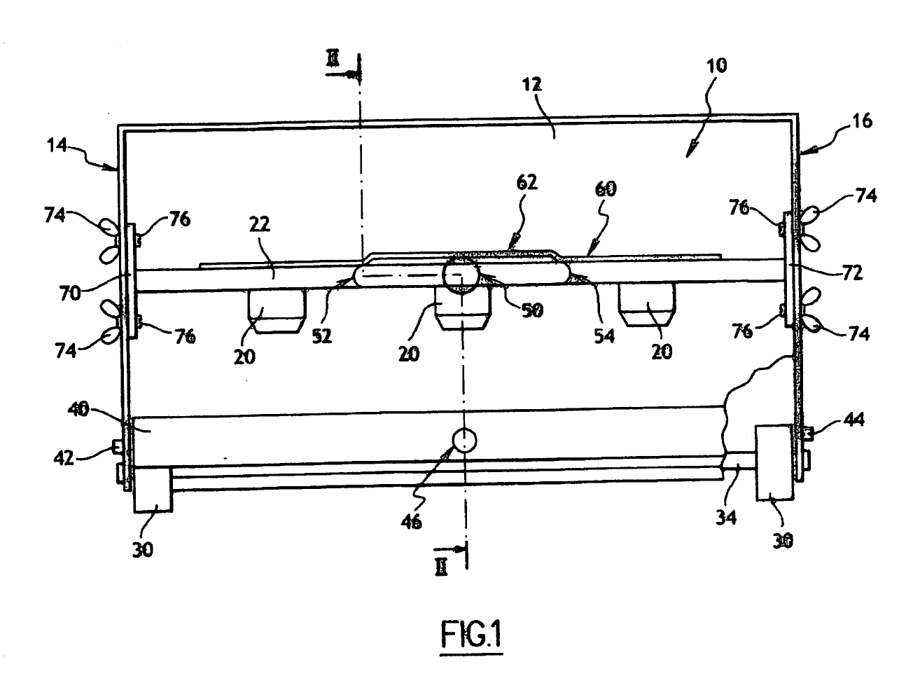

FIG. 1 is a two-dimensional front view of a device according to a particular embodiment of the invention, partly cut away to illustrate the axis of rotation of a wheel.

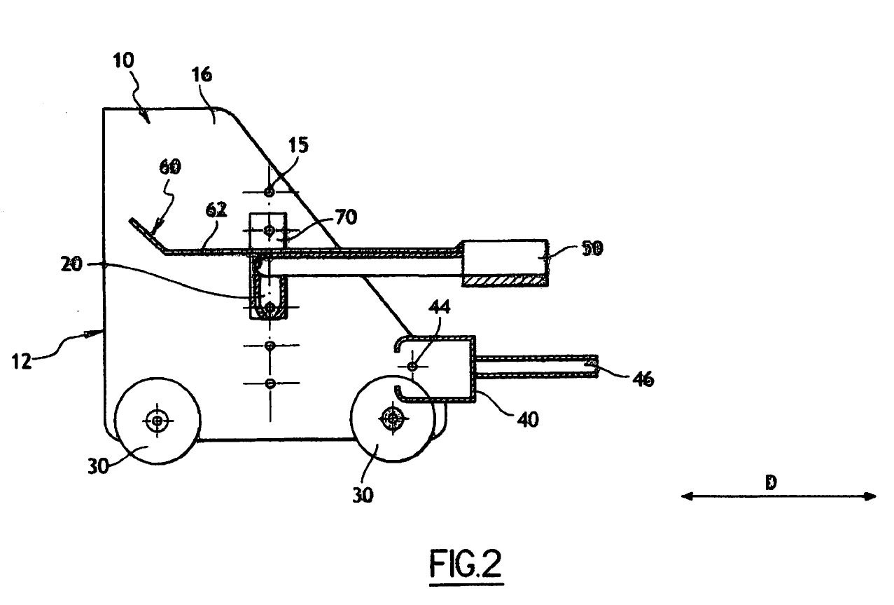

FIG. 2 is a cutaway of the device along 1′-11 according to the same embodiment of the invention.

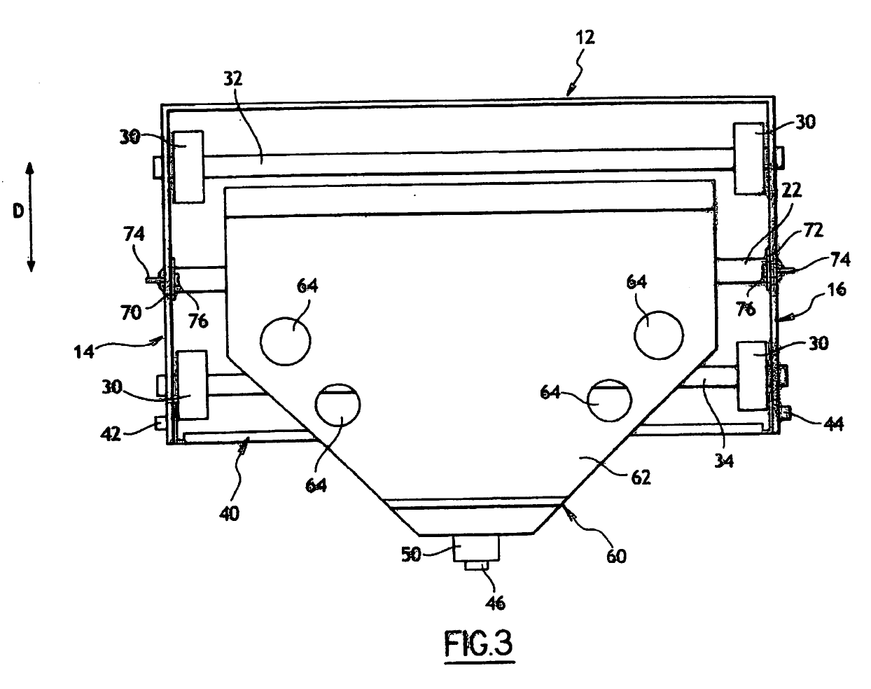

FIG. 3 is a top view of the device according to the same embodiment of the invention.

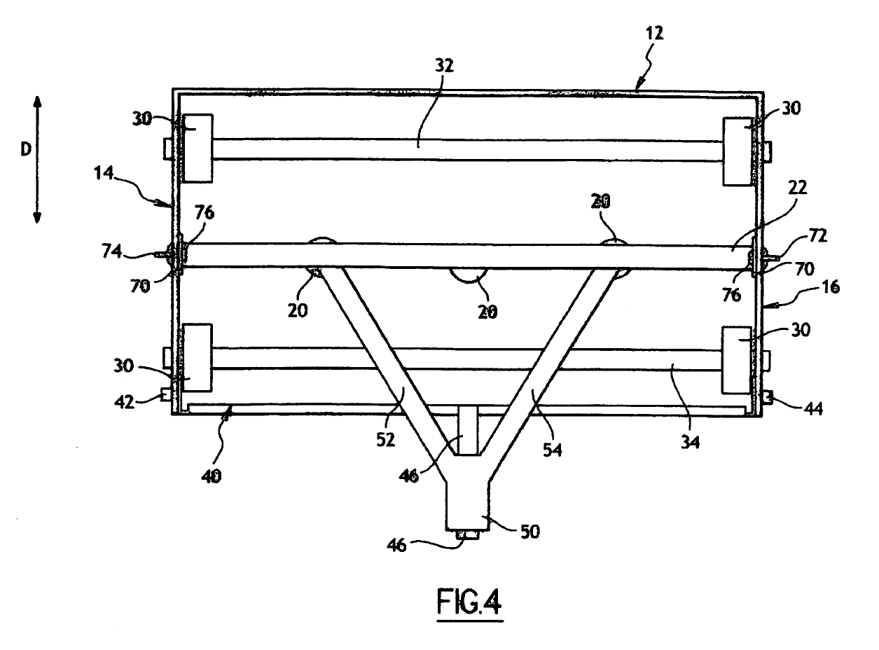

FIG. 4 is a similar view of the top of the device after removal of a stiffening plate.

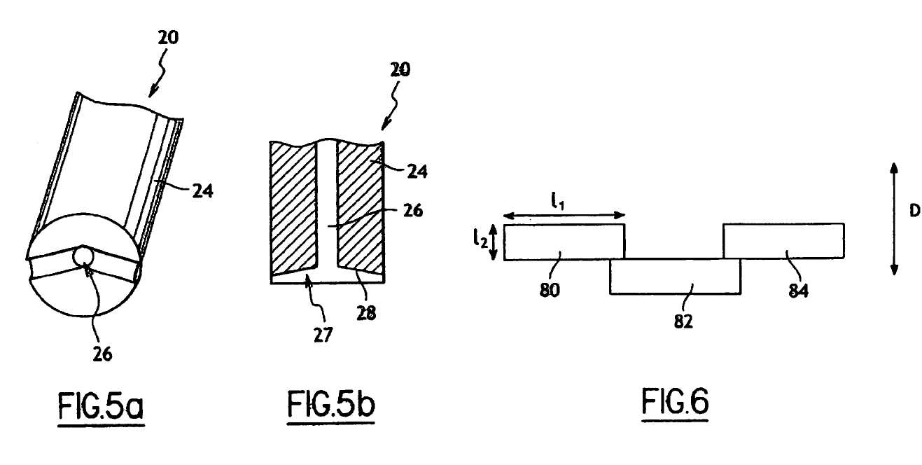

FIGS. 5a and 5b area perspective and cutaway views respectively of a nozzle, and

FIG. 6 is a view of the impact zones of the cleaning-liquid jets on the support.

With reference to FIGS. 1 to 6, we now describe a particular embodiment of the invention. A device according to the invention has:
casing 10
cleaning-liquid spray means 20 mounted on casing 10
points of contact 30 for casing 10 on the support
means 40 articulated with the casing 10 suitable for receiving device handling means

With respect to this particular embodiment, casing 10 consists of U-shaped sheet metal with a central core 12 and two lateral sides 14, 16, both perpendicular during use to the surface of the support to be cleaned. Thus, the casing 10 is open on three sides: the side facing the support, the side opposite to it, and the side located between the two side walls 14, 16, opposite the core 12 and which faces the user, and wherein means 40 articulated with casing 10 mentioned above are located.

In a variant, the side opposite the side facing the support is closed.

The casing 10 must also be sufficiently close to the support to prevent cleaning liquid from projecting beyond the surface to be cleaned. To that end, the height by which points of contact 30 extend beyond the base of the casing 10 is preferably comprised between 0.5 mm and 20 mm, typically on the order of 10 mm.

According to the particular embodiment illustrated in the attached drawings, three cleaning-liquid spray means 20 are provided.

These are formed of nozzles distributed along the length of a principal conduit 22 extending between the two side walls 14, 16, that is, appreciably perpendicular to the direction of movement D effected during cleaning.

The nozzles 20 project beyond the principal conduit 22 and extend at least appreciably parallel to the core 12 and the side walls 14, 16.

The nozzles 20 consist of a cylindrical body 24 having a central bore 26 culminating, at the extremity of body 24, in a diametral throat 27 whose bottom 28 is defined by a concave dihedral (see FIGS. 5a and 5b). This geometry gives the jet exiting the nozzle the shape of a fan, leaving on the support traces of length l₁ and width l₂, which is considerably smaller than l₁ (see FIG. 6).

Preferably, diametral throats 27 of nozzles 20 are oriented parallel to an orthogonal generatrix in the direction of movement D, such that the fan jets in combination cover a support width appreciably equal to casing 10 and such that the liquid is projected onto the surface of the support parallel to the weave of the fabric when the support is made from fabric. In this way, the support is cleaned along the grain for greater washing efficiency.

Preferably, spray means 20 are not all rigorously aligned along a generatrix orthogonal to the direction of movement D.

Preferably, central nozzle 20 is offset with respect to the two others in the direction of cleaning D, which corresponds to the direction of movement of the device. In this way, the jets of the three nozzles 20 do not interfere with or disturb one another, and the impact zones of the cleaning liquid (references 80, 82, 84, on FIG. 6) do not overlap, leaving no marks on the support so that the cleaning of the surface is optimally uniform (see FIG. 6).

In a variant, the three nozzles 20 can be aligned but have slightly different angular orientations in order to generate offset jets on the support, as illustrated in FIG. 6.

Principal conduit 22, whose ends are blocked by plates 70, 72, is fed with cleaning liquid by tip 50, which is then divided into two arms 52, 54, which rejoin the principal conduit 22, on which are mounted cleaning-liquid spray means 20.

The aforementioned arrangements can be used to clean a large surface uniformly.

Cleaning-liquid spray means 20 are formed by small diameter nozzles, for example, on the order of 0.3 mm. They may have an acute spray aperture angle, comprised between 35° and 55° for proper operation. In the case of this particular embodiment, this spray aperture angle is approximately 40° for optimal operation. They are also arranged so as to support an allowable pressure comprised between 30 bars and 130 bars and an allowable temperature comprised between 30° C. and 100° C. The pressure and temperature are adjustable based on the type of support being cleaned. For example, a black or dark color support is treated at a temperature on the order of 30° C.

In the case of this particular embodiment, these cleaning-liquid spray means are high-pressure nozzles 20.

The points of contact 30 are mounted on the casing 10 so as to ensure perfect alignment of the support surface—in the case of a deformable support—on a plane delimited by points of contact 30. This allows a geometric surface to be defined, on which the effect of cleaning-liquid spray means 20 is identical at every point, thus ensuring uniform cleaning at every point of the cleaned surface.

In particular, for this particular embodiment, four points of contact are provided, thus delimiting the largest possible geometric cleaning surface beneath the cleaning-liquid spray perimeter.

These four points of contact can be wheels 30, providing uniform and trouble-free movement on the support. Wheels 30 are preferably mounted rotationally, in respective proximity to the ends of the base of side walls 14, 16, along shafts 32, 34, extending between side walls 14, 16.

The device also has a stiffening plate 60 mounted on the cleaning-liquid feed system 50 to 54 and on the principal conduit 22, behind the high-pressure nozzles 20 with respect to the support. This plate serves to stabilize the cleaning-liquid feed system.

This plate can also be used to protect the user from the cleaning-liquid spray.

In this case, according to this particular embodiment of the invention, the stiffening plate 60 consists of sheet metal 62 capable of entirely covering the cleaning-liquid feed system 50 and nozzles 20 and capable of extending to the three edges of the casing 10. Holes 64 made in plate 60 can be used to evacuate the steam given off by the cleaning liquid exiting the nozzles 20. The user can also observe, through holes 64, the jets of cleaning liquid sprayed onto the support and thereby verify that the device is operating properly.

Means 40 are mounted in articulated manner on casing 10 and are capable of accepting device handling means.

In the present case, this is an articulated U-shaped shell 40 connected in pivoting manner at 42, 44 to side walls 14, 16 of casing 10, at the base of those side walls 14, 16, opposite core 12. This shell 40 is provided with tip 46 for adapting handling means, for example, a long handle, to the device in such a way that, if required to clean a support at a height, it is possible to work from the ground directly upon the support without having to detach it.

The handling means must be sufficiently long to be able to clean the device from the ground without having to use a step ladder, for example.

As indicated previously, according to the invention, means are provided to adjust the height between spray means 20 and the support. Several embodiments are possible for these adjustment means.

Preferably, they comprise two plates 70, 72, joined to the ends of the principal conduit 22 and adapted so they can be attached by any appropriate means, for example screws 74 associated with wing nuts 76 of adjustable height on the outside walls 14, 16. To that end, sides 14, 16 can be provided with a plurality of holes 15 arranged near the top of sides 14, 16 to accommodate screws 74. As a variant, an oblong opening instead of holes provides finer adjustment of the height of spray means 20.

Typically, the distance separating nozzles 20 from one another is comprised between 5 cm and 15 cm, preferably on the order of 9 cm, and the distance separating the exit opening of the nozzles 20 and the support is comprised between 0.5 cm and 10 cm, preferably on the order of 4.5 cm.

Because the height of the nozzles 20 with respect to the support is adjustable, different material surfaces, compositions, and reliefs can be cleaned. Additionally, once the adequate height for a support has been adjusted, it is possible to maintain a given pressure and, therefore, a given impact of the cleaning liquid upon the surface to be cleaned.

Of course, the present invention is not limited to the particular embodiment that has been described but extends to all variants consistent with its intent.

1-16. (canceled)

17. A cleaning device for a support, comprising:
a casing,
at least two cleaning-liquid spray means mounted on the casing,
means for adjusting a distance between the spray means and the support,
wherein, because the device is moved according to a cleaning direction (D), one of the cleaning-liquid spray means is offset with respect to the other in the direction of cleaning (D).

18. The device of claim 17, further comprising at least three points of contact of the casing on the support.

19. The device of claim 18, wherein there are four points of contact of the casing on the support.

20. The device of claim 18, wherein said points of contact comprise wheels.

21. The device of claim 17, further comprising articulated means on the casing suitable for receiving a means for handling the device.

22. The device of claim 17, wherein the cleaning-liquid spray means have an opening with a principal dimension on the order of 0.3 mm.

23. The device of claim 17, wherein the cleaning-liquid spray means have, during operation of the device, an acute angle of spray.

24. The device of claim 23, wherein said angle of spray has a value of approximately 40°.

25. The device of claim 17, wherein the cleaning-liquid spray means are arranged so as to support, during operation, an allowable pressure comprised between approximately 30 bars and approximately 130 bars.

26. The device of claim 17, wherein the cleaning-liquid spray means are arranged so as to support, during operation, an allowable temperature comprised between approximately 30° C. and approximately 100° C.

27. The device of claim 26, further comprising means for stiffening the cleaning liquid feed system, mounted on a cleaning-liquid spray means feed system behind said spray means with respect to the support.

28. The device of claim 17, wherein the cleaning-liquid spray means are high-pressure nozzles.

29. The device of claim 28, wherein the nozzles generate a fan-shaped jet.

30. The device of claim 17, comprising several spray means positioned so that their respective jets are juxtaposed and do not interfere with one another.

31. The device of claim 17, wherein the adjustment means comprise removable attachment means for a conduit bearing the spray means, upon the sides of the casing.

32. A cleaning system for a support, comprising a pressurized cleaning-liquid feed machine including the device of claim 17.
